(19) United States
(12) Patent Application Publication
(10) Pub. No.: US 2009/0226658 A1
(43) Pub. Date: Sep. 10, 2009

(54) Optical Recording Medium

(75) Inventors: Atsushi Monden, Tokyo (JP); Masahiro Shinkai, Tokyo (JP); Motohiro Inoue, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 11/991,575

(22) PCT Filed: Sep. 25, 2006
(86) PCT No.: PCT/JP2006/318974

§ 371 Date: Mar. 6, 2008

(30) Foreign Application Priority Data
Sep. 27, 2005 (JP) 2005-280663

(51) Int. Cl. G11B 7/244; G11B 7/24

(52) U.S. Cl. 428/64.8

(57) ABSTRACT

At least two recording layers are laminated, a dye in each of the recording layers contains predetermined concentrations of a metal complex dye and an organic dye, the recording layers are referred to as first and second recording layers successively from the light entrance surface side, the first recording layer contains 60 to 100 parts by weight of a metal complex dye where the total amount of the metal complex dye and organic dye is 100 parts by weight, and the second recording layer contains 10 to 80 parts by weight of a metal complex dye where the total amount of the metal complex dye and organic dye is 100 parts by weight. A recording medium is provided, in which recording is possible in the first and second recording layers by recording powers equivalent to each other while the initial error rate after a high-temperature storage test is sufficiently low in each recording layer.

### TECHNICAL FIELD

The present invention relates to an optical recording medium capable of recording and reading information by irradiation with light.

### BACKGROUND ART

Optical recording media such as CD-R and DVD-R which have recording layers containing dyes can record a large amount of information while allowing random access. Therefore, they have widely been recognized as external recording devices in information processing systems such as computers and come into widespread use.

In recent years, as the amount of information to be handled has been increasing, optical recording media have been demanded to further increase their recording capacity. Therefore, a so-called single-sided, dual layer optical recording medium which has two dye-containing recording layers provided on a substrate and makes it possible to record information into the two recording layers from one side and read the information recorded in the two recording layers from the one side has been proposed (see, for example, Patent Documents 1 to 4).

In this specification, the recording layers will be referred to as first and second recording layers successively from the light entrance surface side.

Patent Document 1: Japanese Patent Application Laid-Open No. 2003-331463

Patent Document 2: Japanese Patent Application Laid-Open No. 2003-331473

Patent Document 3: Japanese Patent Application Laid-Open No. 2003-178490

Patent Document 4: Japanese Patent Application Laid-Open No. 2003-170664

### DISCLOSURE OF THE INVENTION

### Problem to be Solved by the Invention

In such an optical recording medium, the light reaching the second recording layer farther from the light entrance surface is the light transmitted through the first recording layer and thus is weaker than that arriving at the first recording layer. Therefore, it is necessary for the second recording layer to have a sensitivity higher than that of the first recording layer closer to the light entrance surface, so that recordings are carried out in the first and second recording layers by recording powers substantially equivalent to each other.

On the other hand, it is desirable in such a recording medium that the error rate after a high-temperature storage test be sufficiently low for both the first and second recording layers even when the sensitivity of the second recording layer is made higher than that of the first recording layer.

In view of the circumstances mentioned above, it is an object of the present invention to provide a recording medium which enables recordings in the first and second recording layers by recording powers substantially equivalent to each other, while the initial error rate after the high-temperature storage test is sufficiently low in each of the recording layers.

### Means for Solving Problem

The inventors conducted diligent studies in order to achieve the above-mentioned object and, as a result, have found that, when the compounding ratio between a metal complex dye and an organic dye in the first recording layer and the compounding ratio between a metal complex dye and an organic dye in the second recording layer fall within predetermined ranges, an optical recording medium in which the recording layers have recording powers substantially equivalent to each other while the error rate after the high-temperature storage test is sufficiently good in each of the recording layers is realized, thus achieving the present invention.

The optical recording medium in accordance with the present invention has at least two recording layers laminated, each of the recording layers contains predetermined concentrations of a metal complex dye and an organic dye, the recording layers are referred to as first and second recording layers successively from the light entrance surface side, the first recording layer contains 60 to 100 parts by weight of a metal complex dye where the total amount of the metal complex dye and organic dye is 100 parts by weight, and the second recording layer contains 10 to 80 parts by weight of a metal complex dye where the total amount of the metal complex dye and organic dye is 100 parts by weight.

In such an optical recording medium, the recording powers necessary for recordings in the first and second recording layers become equivalent to each other, while the error rate after the high-temperature storage test is a sufficiently good value for each of the recording layers.

When the first recording layer contains less than 60 parts by weight of the metal complex dye where the total amount of the metal complex dye and organic dye is 100 parts by weight, by contrast, the error rate after the high-temperature storage test in the first recording layer increases. When the second recording layer contains less than 10 parts by weight of the metal complex dye where the total amount of the metal complex dye and organic dye is 100 parts by weight, on the other hand, the error rate after the high-temperature storage test in the second recording layer increases. When the second recording layer contains more than 80 parts by weight of the metal complex dye where the total amount of the metal complex dye and organic dye is 100 parts by weight, the recording power of the second recording layer increases so as to become out of balance with the recording power of the first recording layer.

Though the reason why such a favorable optical recording medium is obtained by the concentration conditions of the above-mentioned recording layers is not completely clear, the difference in thermal stability between the organic dye and metal complex dye is assumed to be involved therein. In general, the metal complex dye is thermally more stable than the organic dye, so that a recording layer seems to become thermally more stable as the metal complex dye amount increases therein. However, the high thermal stability conversely worsens the recording sensitivity, whereby it seems important to optimize the compounding ratio.

Preferably, the first recording layer contains 60 to 80 parts by weight of the metal complex dye where the total amount of the metal complex dye and organic dye is 100 parts by weight. This realizes a medium which is excellent in recording power balance while having a sufficiently low recording power.

Preferably, the second recording layer contains 30 to 50 parts by weight of the metal complex dye where the total amount of the metal complex dye and organic dye is 100 parts by weight. In this case, the balance in recording power between the first and second recording layers becomes better, and the error rate after the high-temperature storage test decreases more.

It will be preferred in particular if the first recording layer contains 60 to 80 parts by weight of the metal complex dye where the total amount of the metal complex dye and organic dye is 100 parts by weight while the second recording layer contains 30 to 50 parts by weight of the metal complex dye where the total amount of the metal complex dye and organic dye is 100 parts by weight.

Preferably, the metal complex dye is an azo metal complex dye.

It will be preferred in particular if the azo metal complex dye is a complex compound formed by an azo compound represented by the following general formula (1) and a metal:

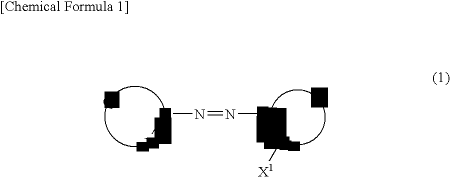

In formula (1), Q¹ indicates a divalent residue forming a heterocyclic ring or a fused ring including the heterocyclic ring by combining with each of a nitrogen atom and a carbon atom combined to the nitrogen atom, Q² indicates a divalent residue forming a fused ring by combining with each of two carbon atoms combined to each other, and X¹ indicates a functional group having at least one active hydrogen atom.

Preferably, the organic dye is a cyanine dye.

Preferably, the cyanine dye has a group represented by the following general formula (2) or (3):

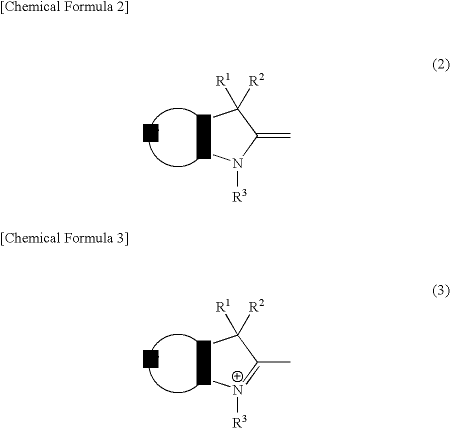

In formulas (2) and (3), Q³ indicates an atom group constituting a benzene ring which may have a substituent or a naphthalene ring which may have a substituent; R¹ and R² independently indicate an alkyl group, a cycloalkyl group, a phenyl group, or a benzyl group which may have a substituent, or groups forming a 3- to 6-membered ring by combining with each other; R³ indicates an alkyl group, a cycloalkyl group, an alkoxy group, a phenyl group, or a benzyl group which may have a substituent; and the groups expressed by R¹, R², and R³ may have a substituent.

Preferably, the recording layers are provided by only two layers.

A specific structure of the optical recording medium in accordance with the present invention comprises a substrate, the above-mentioned first recording layer provided on the substrate, a semitransparent reflecting layer provided on the first recording layer, a spacer layer provided on the semitransparent reflecting layer, the above-mentioned second recording layer provided on the spacer layer, and a reflecting layer provided on the second recording layer.

### EFFECT OF THE INVENTION

The present invention can provide an optical recording medium which is excellent in the balance in recording power between the first and second recording layers while the error rate after the high-temperature storage test is sufficiently low in both recording layers.

### BRIEF DESCRIPTION OF THE DRAWINGS

FIG. 1 is a schematic sectional view of an optical recording medium in accordance with the present invention.

FIG. 2 is a table showing structures of recording layers in accordance with Examples a1 to a12 and results of evaluation of characteristics in the recording layers.

FIG. 3 is a table showing structures of recording layers in accordance with Comparative Examples a1 to a30 and results of evaluation of characteristics in the recording layers.

FIG. 4 is a table showing structures of recording layers in accordance with Examples b1 to b11 and Comparative Examples b1 to b6.

### EXPLANATIONS OF NUMERALS

10 . . . substrate; 20 . . . first recording layer; 30 . . . semitransparent reflecting layer; 40 . . . spacer layer; 50 . . . second recording layer; 60 . . . reflecting layer; 70 . . . adhesive layer; 80 . . . dummy substrate; 12, 42 . . . groove; 100 . . . optical recording medium.

### BEST MODES FOR CARRYING OUT THE INVENTION

In the following, preferred embodiments of the present invention will be explained in detail with reference to the drawings as necessary. Positional relationships such as upper, lower, left, and right are based on those shown in the drawings unless otherwise noted in particular. Ratios of dimensions in the drawings are not limited to those depicted.

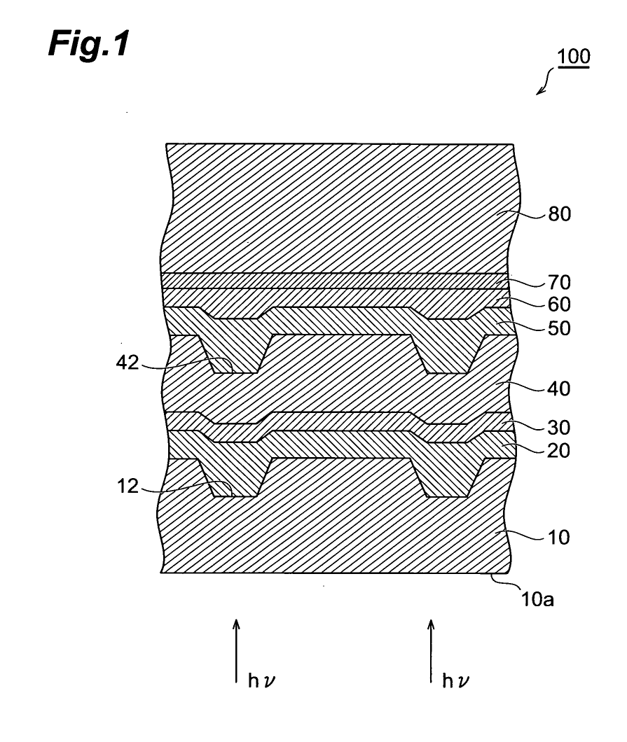

First, with reference to FIG. 1, the structure of the optical recording medium in accordance with an embodiment will be explained. FIG. 1 is a partial sectional view showing a preferred embodiment of the optical recording medium 100 in accordance with the present invention. The optical recording medium 100 shown in FIG. 1 has a multilayer structure in which a first recording layer 20, a semitransparent reflecting layer 30, a spacer layer 40, a second recording layer 50, a reflecting layer 60, an adhesive layer 70, and a dummy substrate 80 are successively provided in close contact with one another on a substrate 10. The optical recording medium 100 is a write-once optical recording disc which is capable of recording/reading by light having a short wavelength of 630 to 685 nm. The light for recording and reading irradiates the optical recording medium 100 from the substrate 10 side, i.e., from the lower side of FIG. 1.

Substrate 10

The substrate 10 is shaped like a disc having a diameter of about 64 to 200 mm and a thickness of about 0.6 mm, for example. Recording into the first recording layer 20 and second recording layer 50 and reading data from these recording layers are performed by the light incident thereon from the substrate 10. Therefore, it will be preferred if at least the substrate 10 is substantially transparent to the recording light and reading light. More specifically, it will be preferred if the substrate 10 exhibits a transmittance of at least 88% to the recording light and reading light. As a material for the substrate 10, glass or resins satisfying the above-mentioned condition concerning the transmittance are preferred, among which thermoplastic resins such as polycarbonate resins, acrylic resins, amorphous polyethylene, TPX, and polystyrene-based resins are preferred in particular.

A tracking groove 12 is formed as a recess on the surface of the substrate 10 formed with the first recording layer 20, i.e., on the inner face side. The groove 12 is preferably a spiral continuous groove, while its depth, width, and groove pitch are preferably 0.1 to 0.25 μm, 0.20 to 0.50 μm, and 0.6 to 1.0 μm, respectively. When the groove has such a structure, a favorable tracking signal can be obtained without lowering the reflection level of the groove. The groove 12 can be formed simultaneously with forming the substrate 10 by injection molding or the like using the above-mentioned resin. Alternatively, a resin layer having the groove 12 may be formed by the 2P method or the like after manufacturing the substrate 10, so as to construct a composite substrate constituted by the substrate 10 and this resin layer.

First Recording Layer 20

The first recording layer 20 is a layer containing a predetermined optical recording material. The structure of the first recording layer 20 will now be explained in detail.

The first recording layer 20 contains a metal complex dye, and also an organic dye as necessary. The first recording layer 20 contains 60 to 100 parts by weight of the metal complex dye where the total amount of the metal complex dye and organic dye is 100 parts by weight. It will be preferred in particular if the first recording layer 20 contains 60 to 80 parts by weight of the metal complex dye where the total amount of the metal complex dye and organic dye is 100 parts by weight.

Metal Complex Dye

First, the metal complex dye will be explained. Employable as the metal complex dye are various metal complex dyes such as azo metal complex dyes, indoaniline metal complex dyes, ethylenediamine metal complex dyes, azomethine metal complex dyes, phenylhydroxylamine metal complex dyes, phenanthroline metal complex dyes, nitrosoaminophenol metal complex dyes, pyridyltriazine metal complex dyes, acetylacetonate metal complex dyes, metallocene metal complex dyes, and porphyrin complex dyes. Preferred in particular as the metal complex dye among them are azo metal complex dyes, i.e., complex compounds formed by an azo compound and a metal. Mixtures of a plurality of metal complex dyes may also be employed.

The azo metal complex dyes are not limited in particular as long as they are complex compounds formed by an azo compound having a functional group (azo group) expressed by —N═N— and a metal. Examples of the azo metal complex dyes include complex compounds formed by an azo compound in which aromatic rings are combined to the two nitrogen atoms of the above-mentioned azo group, respectively, and a metal. A more specific example is a complex compound formed by an azo compound represented by the following general formula (1) and a metal:

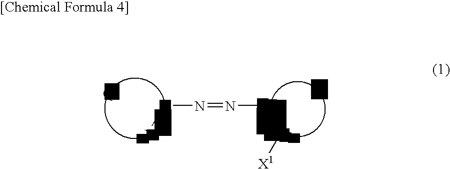

In formula (1), Q¹ indicates a divalent residue forming a heterocyclic ring or a fused ring including the heterocyclic ring by combining with each of a nitrogen atom and a carbon atom combined to the nitrogen atom. Q² indicates a divalent residue forming a fused ring by combining with each of two carbon atoms combined to each other.

X¹ is a functional group having at least one active hydrogen atom. Its examples include hydroxyl group (—OH), thiol group (—SH), amino group (—NH₂), carboxy group (—COOH), amide group (—CONH₂), sulfonamide group (—SO₂NH₂), sulfo group (—SO₃H), —NSO₂CF₃, and the like.

Examples of such an azo compound include compounds represented by the following general formulas (4) to (7):

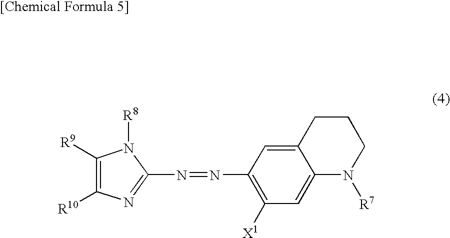

In formula (4), R⁷ and R⁸ may be identical to or different from each other and independently indicate an alkyl group having a carbon number of 1 to 4; R⁹ and R¹⁰ may be identical to or different from each other and independently indicate a nitrile group or carboxylate ester group; and X¹ is defined as with the one mentioned above. Preferred as the above-mentioned carboxylate ester group is —COOCH₃, —COOC₂H₅, or —COOC₃H₅.

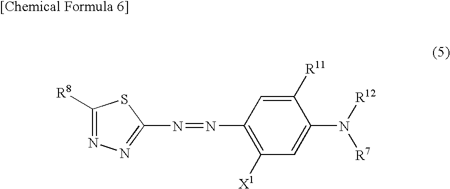

In formula (5), R⁷ indicates a hydrogen atom or an alkoxy group having a carbon number of 1 to 3; R¹², R⁷, and R⁸ may be identical to or different from each other and independently indicate an alkyl group having a carbon number of 1 to 4; and X¹ is defined as with the one mentioned above.

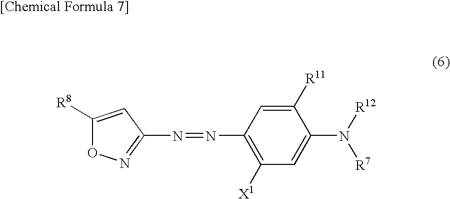

In formula (6), R¹¹, R¹², R⁷, R⁸, and X¹ are defined as with R¹¹, R¹², R⁷, R⁸, and X¹ in formula (5).

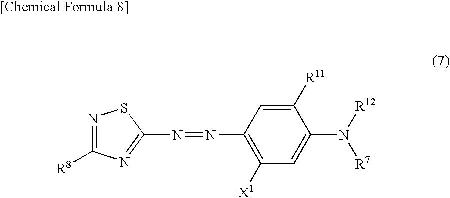

In formula (7), R¹¹, R¹², R⁷, R⁸, and X¹ are defined as with R¹¹R¹², R⁷, R⁸, and X¹ in formula (5).

Examples of the metal (center metal) constituting the above-mentioned complex compound include titanium (Ti), vanadium (V), chromium (Cr), manganese (Mn), iron (Fe), cobalt (Co), nickel (Ni), copper (Cu), zirconium (Zr), niobium (Nb), molybdenum (Mo), ruthenium (Ru), rhodium (Rh), palladium (Pd), silver (Ag), cadmium (Cd), indium (In), tin (Sn), antimony (Sb), tungsten (W), rhenium (Re), osmium (Os), iridium (Ir), platinum (Pt), and gold (Au). V, Mo, and W as metals may also be contained as VO²⁺, VO³⁺, MoO²⁺, MoO³⁺, WO³⁺, and the like which are their oxide ions.

Examples of the complex compounds formed by the azo compound of general formula (1) and the metal include complex compounds represented by the following general formulas (8), (9), and (10) and complex compounds (Nos. A1 to A49) shown in the following Tables 1 to 6. These complex compounds are used singly or in combination of two or more. In the complex compounds shown in Nos. A1 to A49, two azo compounds are coordinated with each element of the center metal. Those listing two species each of the azo compound and center metal indicate that they are contained at a molar ratio of 1:1, while those representing the center metal by “V═O” indicate that an azo compound is coordinated with acetylacetone vanadium.

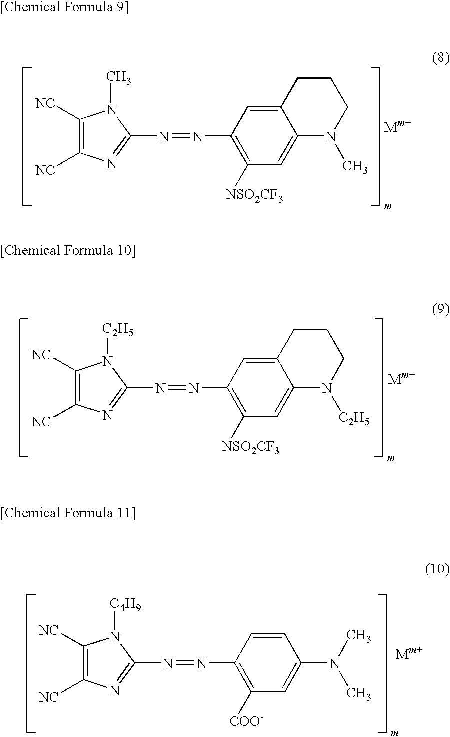

In general formulas (8), (9), and (10), M indicates Ni²⁺, Co²⁺, or Cu²⁺, and m indicates the valence of M.

TABLE 1

| No. | AZO COMPOUND | CENTER METAL |
|---|---|---|
| A1 | 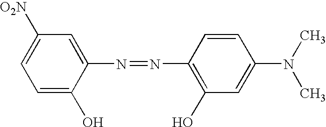 | Co |
| A2 | 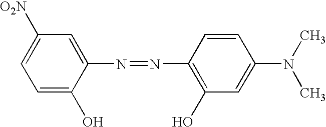 | V═O |
| A3 | 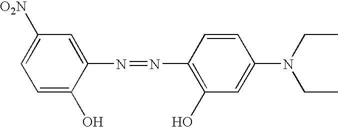 | Co |
| A4 | 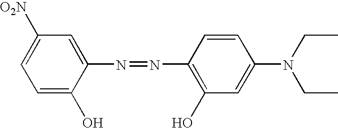 | V═O |
| A5 | 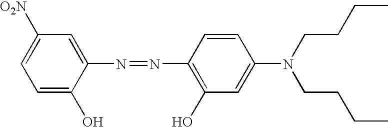 | Co |
| A6 | 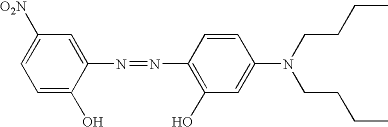 | V═O |
| A7 | 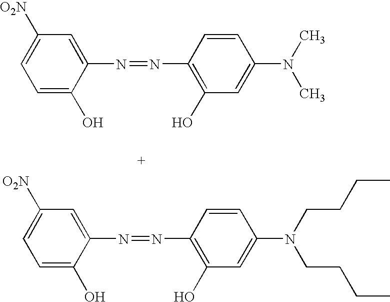 | Co |
| A8 | 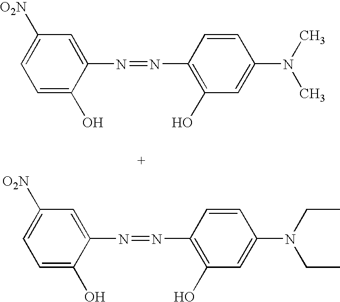 | Co |

TABLE 2

| No. | AZO COMPOUND | CENTER METAL |
|---|---|---|
| A9 | 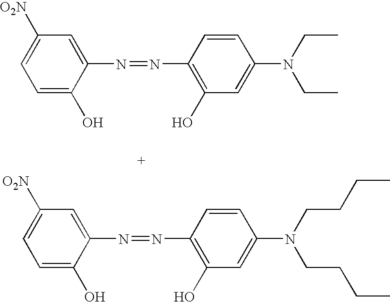 | Co |
| A10 | 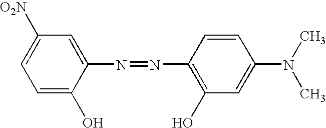 | Co + V═O |
| A11 | 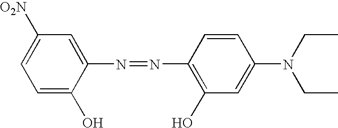 | Co + V═O |
| A12 | 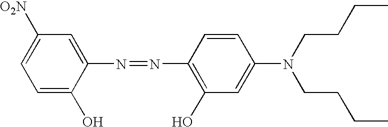 | Co + V═O |
| A13 | 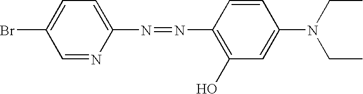 | Cu |
| A14 | 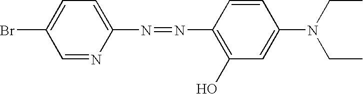 | Ni |
| A15 | 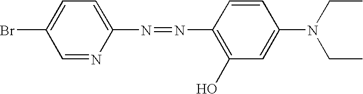 | Co |
| A16 | 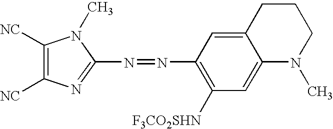 | Ni |
| A17 | 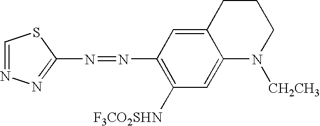 | Ni |

TABLE 3

| No. | AZO COMPOUND | CENTER METAL |
|---|---|---|
| A18 | 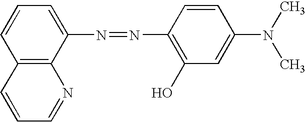 | Co |
| A19 | 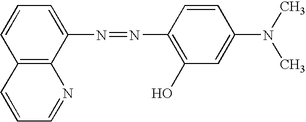 | Ni |
| A20 | 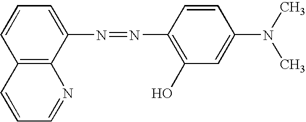 | Cu |
| A21 | 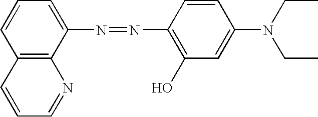 | Co |
| A22 | 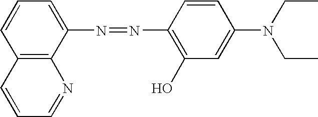 | Ni |
| A23 | 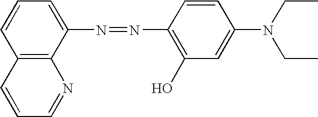 | Cu |
| A24 | 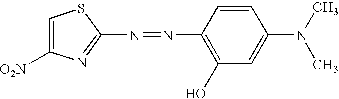 | Cu |
| A25 | 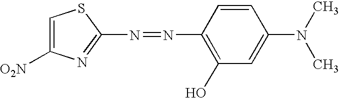 | Ni |
| A26 | 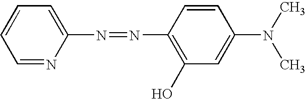 | Cu |
| A27 | 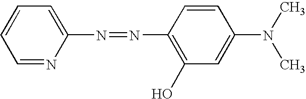 | Ni |

TABLE 4

| No. | AZO COMPOUND | CENTER METAL |
|---|---|---|
| A28 | 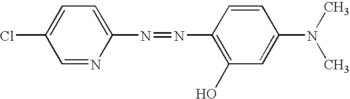 | Cu |
| A29 | 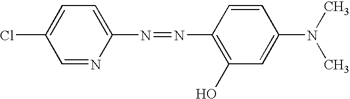 | Ni |
| A30 | 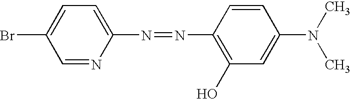 | Cu |
| A31 | 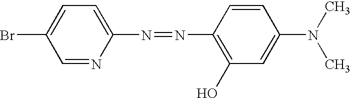 | Ni |
| A32 | 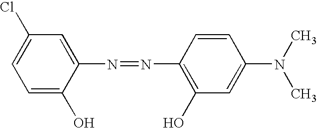 | Co |
| A33 | 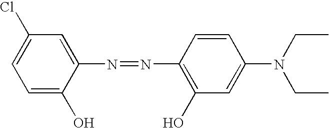 | Co |
| A34 | 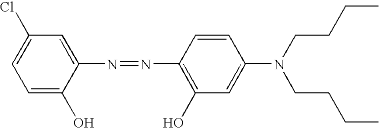 | Co |
| A35 | 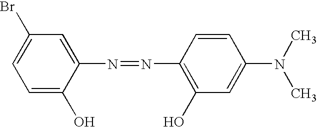 | Co |
| A36 | 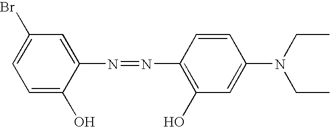 | Co |
| A37 | 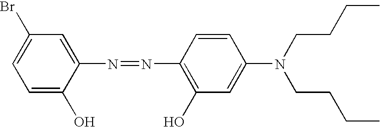 | Co |

TABLE 5

| No. | AZO COMPOUND | CENTER METAL |
|---|---|---|
| A38 | 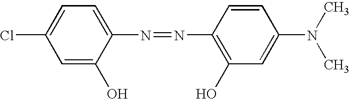 | Co |
| A39 | 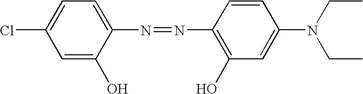 | Co |
| A40 | 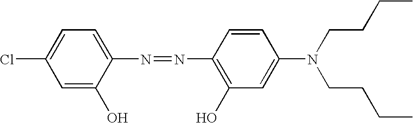 | Co |
| A41 | 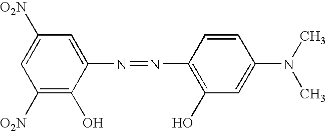 | Co |
| A42 | 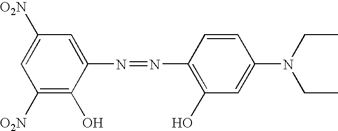 | Co |
| A43 | 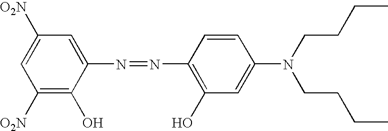 | Co |
| A44 | 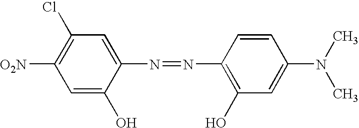 | Co |
| A45 | 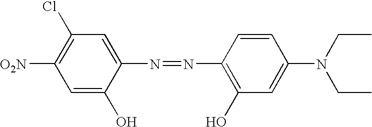 | Co |
| A46 | 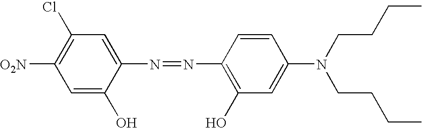 | Co |
| A47 | 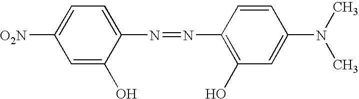 | Co |

TABLE 6

| No. | AZO COMPOUND | CENTER METAL |
|---|---|---|
| A48 | 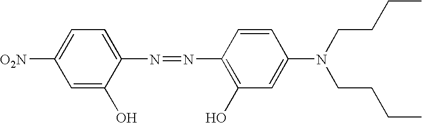 | Co |
| A49 | 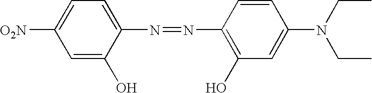 | Co |

Preferred among them are complex compounds represented by A13 to A31. The complex compound may also be one having a structure excluding the nitro group and diethylamine group from the molecule represented by the compound A49.

Depending on the species of X¹, the complex compound may be formed in the state where active hydrogen owned by X¹ is dissociated.

The above-mentioned complex compound may form salts with a counter cation and a counter anion when the complex compound exists as an anion and a cation, respectively. In this specification, the weight of the metal complex dye does not include the weight of the counter ion. Preferably used as the counter cation are alkali metal ions such as Na⁺, Li⁺, and K⁺ and ammonium ion. Salts may also be formed by employing cyanine dyes, which will be explained later, as a counter cation. Namely, when the organic dye, which will be explained later, is a cationic dye or anionic dye, this may also be used as a counter ion. Preferably used as other counter anions are PF₆⁻, I⁻, BF₄⁻, an anion represented by the following formula (11), and the like.

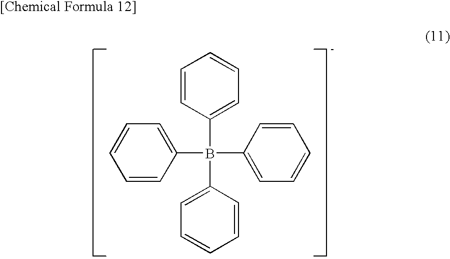

Such a complex compound can be synthesized according to a known method (see, for example, Furukawa, Anal. Chem. Acta., 140, 289 (1982)).

Organic Dye

The organic dye will now be explained. The organic dye may be any of known ones or those synthesizable by or according to a known method, as long as they are organic dyes other than the metal complex dye. Its examples include cyanine dyes, squarylium dyes, croconium dyes, azulenium dyes, xanthene dyes, merocyanine dyes, triarylamine dyes, anthraquinone dyes, azomethine dyes, oxonol dyes, intermolecular CT dyes, and the like.

Preferred among them are cyanine dyes, those having a group represented by the following general formula (2) or (3) in particular:

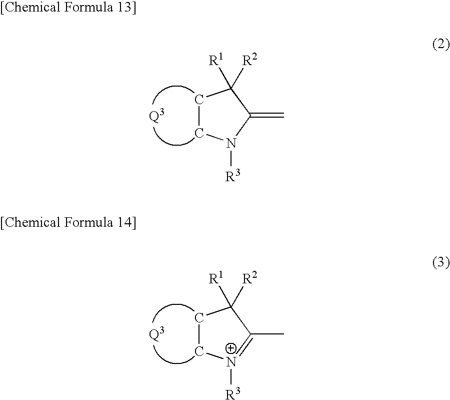

In formulas (2) and (3), Q³ indicates an atom group constituting a benzene ring which may have a substituent or a naphthalene group which may have a substituent; R¹ and R² independently indicate an alkyl group, a cycloalkyl group, a phenyl group, a benzyl group which may have a substituent, or groups forming a 3- to 6-membered ring by combining with each other; R³ indicates an alkyl group, a cycloalkyl group, an alkoxy group, a phenyl group, or a benzyl group which may have a substituent; and the groups expressed by R¹, R², and R³ may have a substituent.

Examples of such cyanine dyes include a cyanine dye expressed by the following general formula (12):

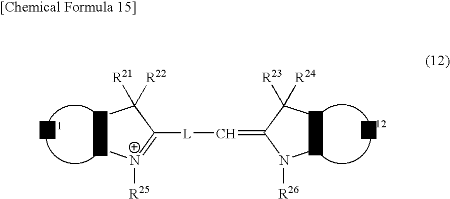

In the formula, L indicates a divalent bonding group represented by the following general formula (13a); R²¹ and R²² independently indicate an alkyl group having a carbon number of 1 to 4, a benzyl group which may have a substituent, or groups forming a 3- to 6-membered ring by combining with each other; R²³ and R²⁴ independently indicate an alkyl group having a carbon number of 1 to 4 or a benzyl group which may have a substituent, or indicate groups forming a 3- to 6-membered ring while they bind to each other; R²⁵ and R²⁶ independently indicate an alkyl or aryl group having a carbon number of 1 to 4; and Q¹¹ and Q¹² independently indicate a benzene ring which may have a substituent or a naphthalene ring which may have a substituent. Here, at least one of R²¹, R²², R²³, and R²⁴ indicates a group other than a methyl group, while the divalent bonding group represented by the following general formula (13a) may have a substituent.

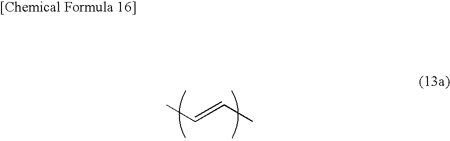

More specific examples of cyanine dyes include compounds (Nos. T1 to T67) listed in the following Tables 7 to 12:

TABLE 7

| No. | |
|---|---|
| T1 | 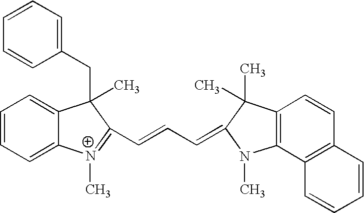 |
| T2 | 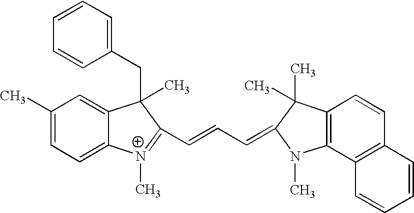 |
| T3 | 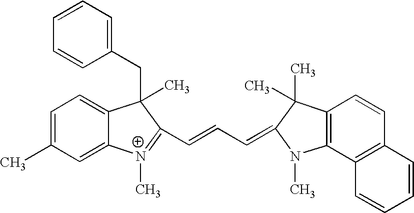 |
| T4 | 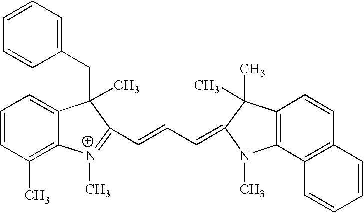 |
| T5 | 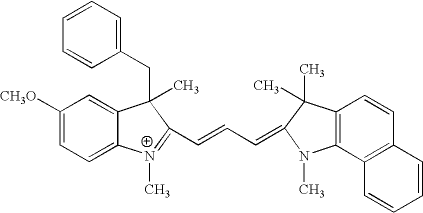 |
| T6 | 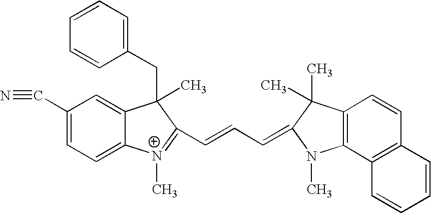 |
| T7 | 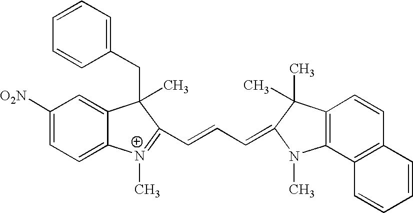 |
| T8 | 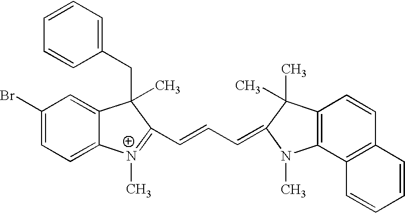 |
| T9 | 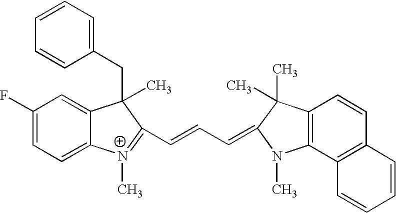 |
| T10 | 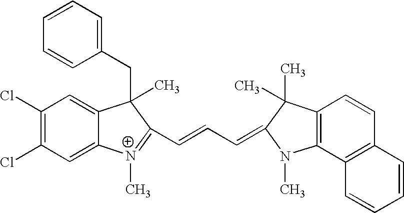 |
| T11 | 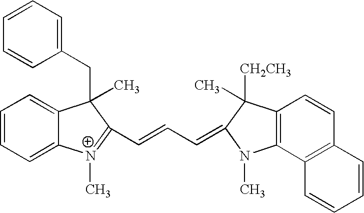 |
| T12 | 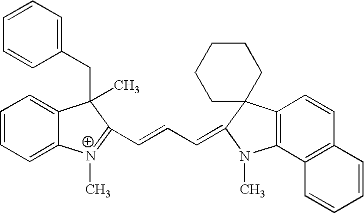 |

TABLE 8

| No. | |
|---|---|
| T13 | 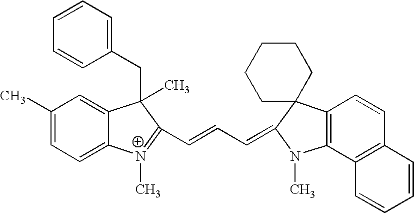 |
| T14 | 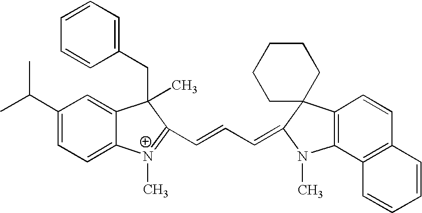 |
| T15 | 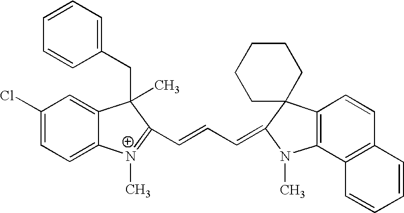 |
| T16 | 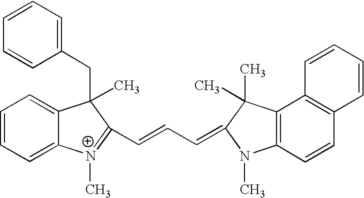 |
| T17 | 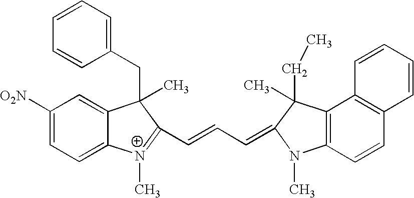 |
| T18 | 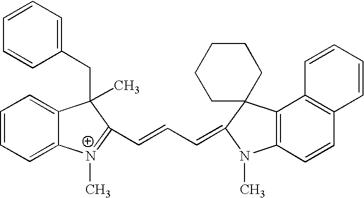 |
| T19 | 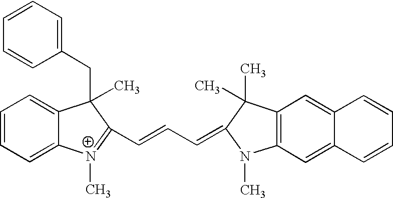 |
| T20 | 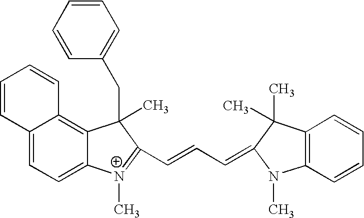 |
| T21 | 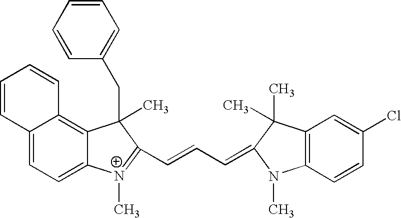 |
| T22 | 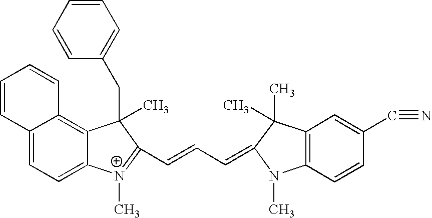 |
| T23 | 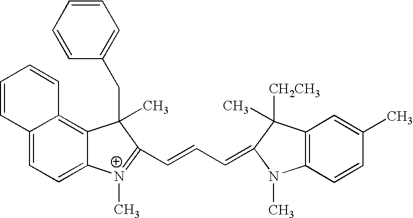 |
| T24 | 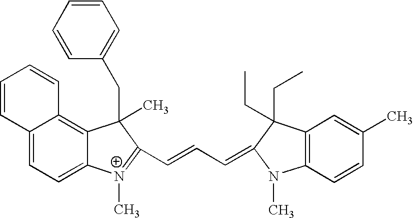 |

TABLE 9

| No. | |
|---|---|
| T25 | 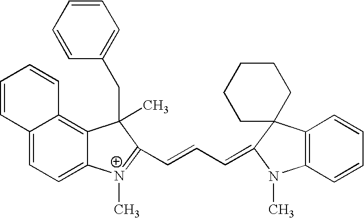 |
| T26 | 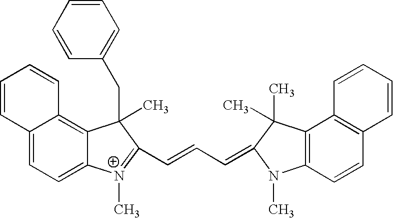 |
| T27 | 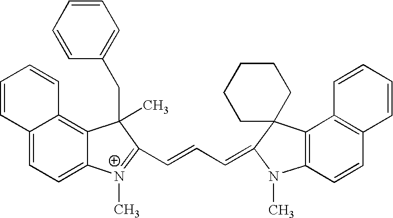 |
| T28 | 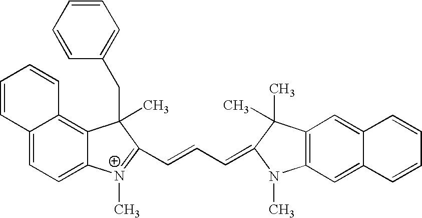 |
| T29 | 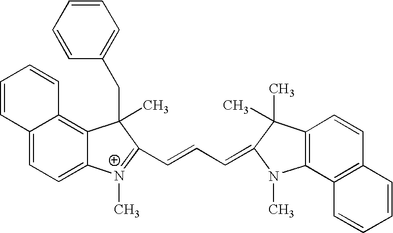 |
| T30 | 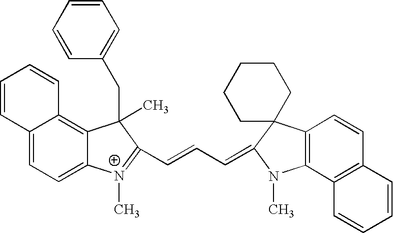 |
| T31 | 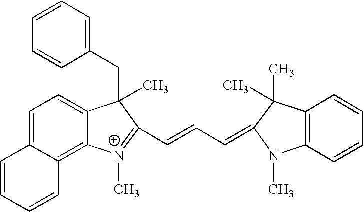 |
| T32 | 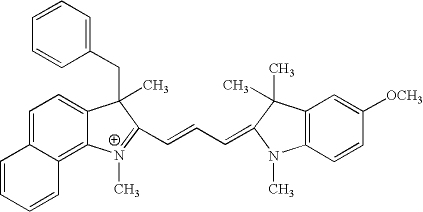 |
| T33 | 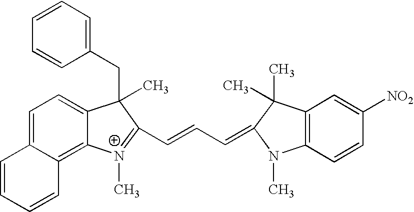 |
| T34 | 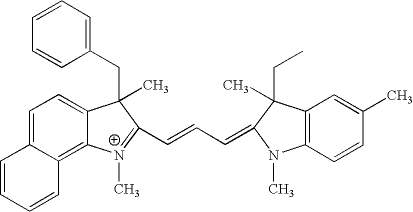 |
| T35 | 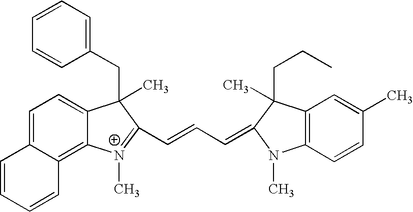 |
| T36 | 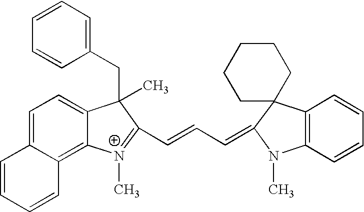 |

TABLE 10

| No. | |
|---|---|
| T37 | 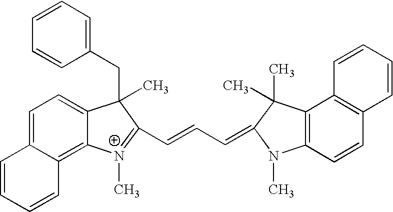 |
| T38 | 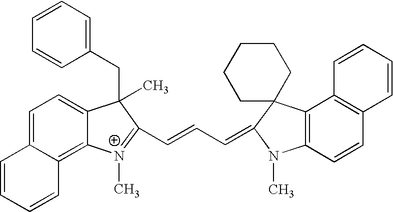 |
| T39 | 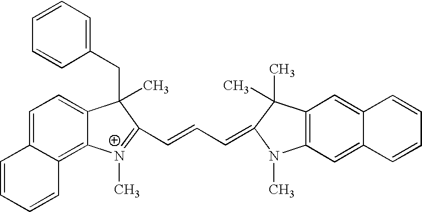 |
| T40 | 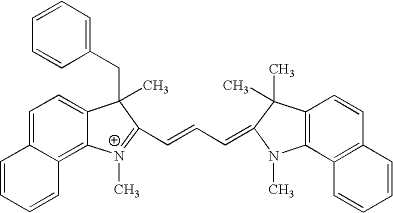 |
| T41 | 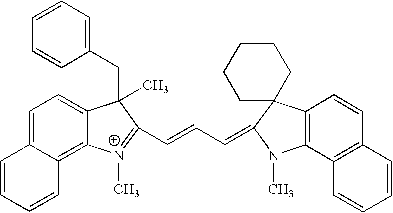 |
| T42 | 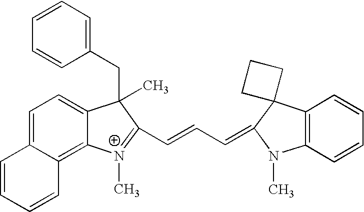 |
| T43 | 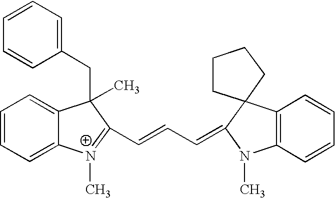 |
| T44 | 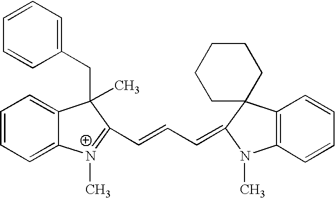 |
| T45 | 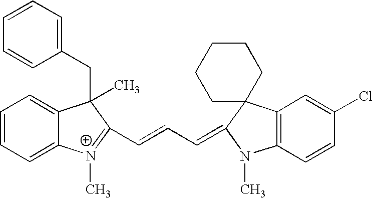 |
| T46 | 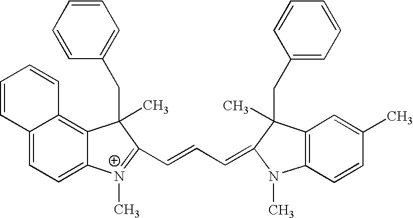 |
| T47 | 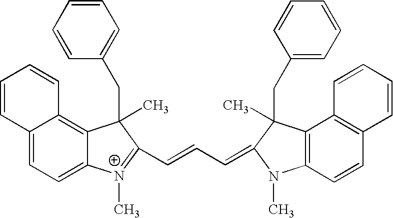 |
| T48 | 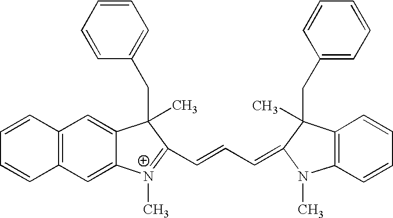 |

TABLE 11

| No. | |
|---|---|
| T49 | 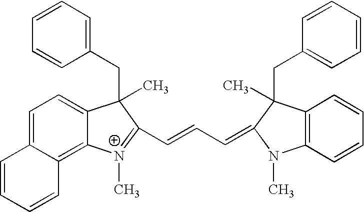 |
| T50 | 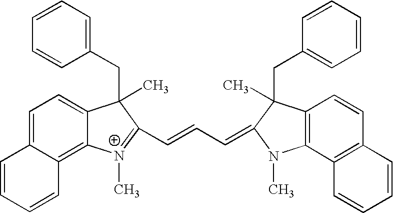 |
| T51 | 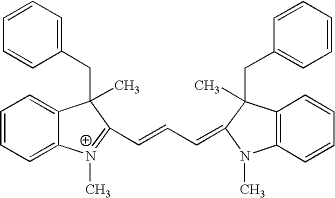 |
| T52 | 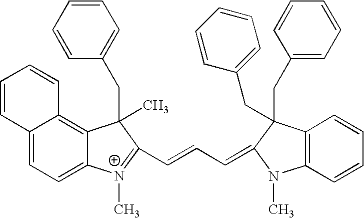 |
| T53 | 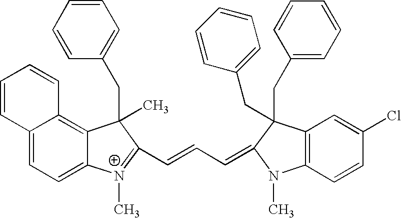 |
| T54 | 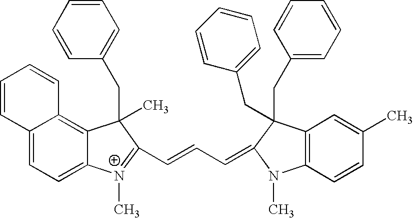 |
| T55 | 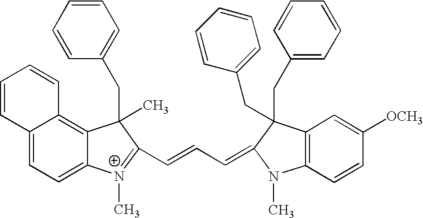 |
| T56 | 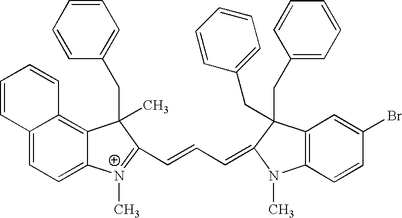 |
| T57 | 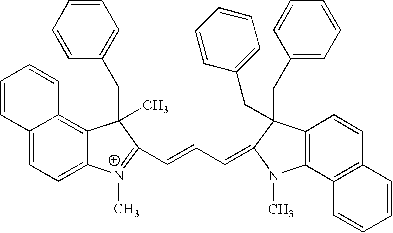 |
| T58 | 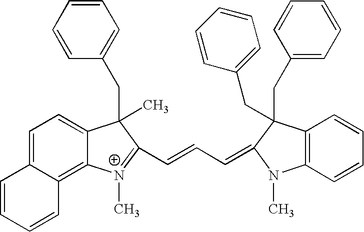 |
| T59 | 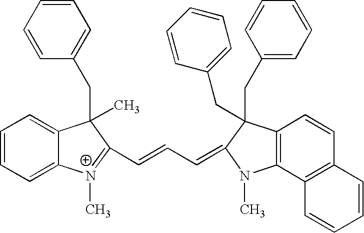 |
| T60 | 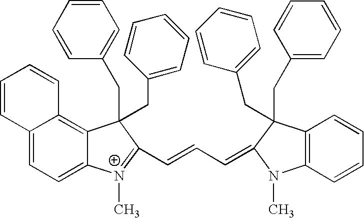 |

TABLE 12

| No. | |
|---|---|
| T61 | 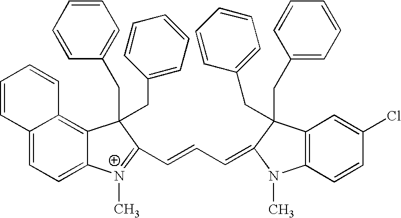 |
| T62 | 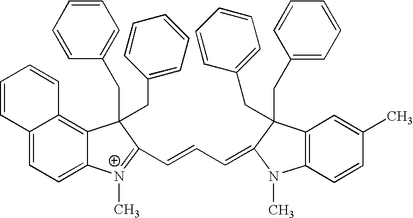 |
| T63 | 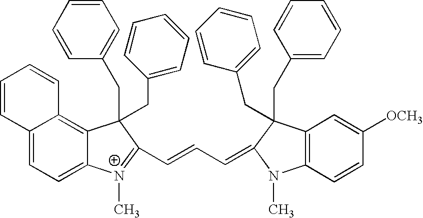 |
| T64 | 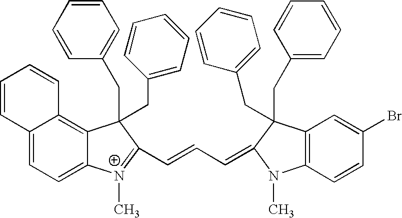 |
| T65 | 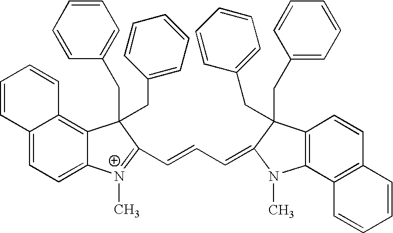 |
| T66 | 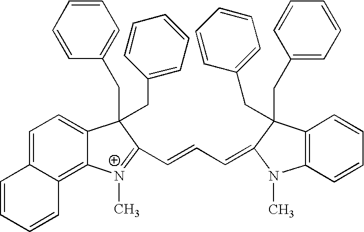 |
| T67 | 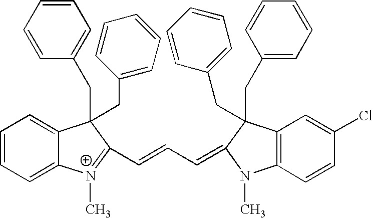 |

The organic dyes are in the forms of cationic (cation) dyes such as the above-mentioned cyanine dyes (T1 to T67), anionic (anion) dyes, and nonionic (neutral) dyes. Specific examples of counter anions when the organic dye is a cationic dye include halide ions (Cl⁻, Br⁻, I⁻, etc.), ClO₄⁻, BF₄⁻, PF₆⁻, VO₃⁻, VO₄³⁻, WO₄²⁻, CH₃SO₃⁻, CF₃COO⁻, CH₃COO⁻, HSO₄⁻, CF₃SO₃⁻, paratoluenesulfonate ion (PTS⁻), p-trifluoromethylphenylsulfonate ion (PFS⁻), and the like. Preferred among them are ClO₄⁻, BF₄⁻, PF₆⁻, SbF₆⁻, and the like. Preferably used as counter cations when the organic dye is an anionic dye are alkali metal ions such as Na⁺, Li⁺, and K⁺, ammonium ion, and the like. The counter ions set forth in the section of metal complex dye and the metal complex dyes themselves are also preferably used as the counter ions. In this specification, the weight of organic dyes does not include that of counter ions.

Method of Manufacturing First Recording Layer

A method of producing such a first recording layer may comprise dissolving or dispersing a metal complex dye and an organic dye into a solvent by the above-mentioned concentration ratio, so as to yield a mixed liquid; applying this mixed liquid onto the substrate 10; removing the solvent from the applied film; and so forth. Examples of the solvent for the mixed liquid include alcohol-based solvents (including those based on keto alcohols, and those based on alkoxy alcohols such as those based on ethylene glycol monoalkyl ethers), aliphatic-hydrocarbon-based solvents, ketone-based solvents, ester-based solvents, ether-based solvents, aromatic solvents, alkyl-halide-based solvents, and the like, among which alcohol-based solvents and aliphatic-hydrocarbon-based solvents are preferred.

Preferred as the alcohol-based solvents are those based on alkoxy alcohols, keto alcohols, and the like. Preferably, in the alkoxy-alcohol-based solvents, the alkoxy part has a carbon atom number of 1 to 4, while the alcohol part has a carbon atom number of 1 to 5, more preferably 2 to 5, and the total carbon atom number is 3 to 7. Specific examples include those based on ethylene glycol monoalkyl ether (cellosolve) such as ethylene glycol monomethyl ether (methylcellosolve), ethylene glycol monoethyl ether (ethylcellosolve, also known as ethoxyethanol), butylcellosolve, and 2-isopropoxy-1-ethanol, 1-methoxy-2-propanol, 1-methoxy-2-butanol, 3-methoxy-1-butanol, 4-methoxy-1-butanol, and 1-ethoxy-2-propanol. Examples of those based on keto alcohols include diacetone alcohol and the like. Fluorinated alcohols such as 2,2,3,3-tetrafluoropropanol can also be used favorably.

Preferred as the aliphatic-hydrocarbon-based solvents are n-hexane, cyclohexane, methylcyclohexane, ethylcyclohexane, cyclooctane, dimethylcyclohexane, n-octane, isopropylcyclohexane, t-butylcyclohexane, and the like, among which preferred are ethylcyclohexane, dimethylcyclohexane, and the like.

Examples of the ketone-based solvents include cyclohexanone and the like.

Preferred in particular in this embodiment are fluorinated alcohols such as 2,2,3,3-tetrafluoropropanol. Also preferred are those based on alkoxy alcohols such as those based on ethylene glycol monoalkyl ether, among which ethylene glycol monoethyl ether, 1-methoxy-2-propanol, 1-methoxy-2-butanol, and the like are preferred. The solvents may be used either singly or in a mixed solvent of two or more species. For example, a mixed solvent of ethylene glycol monoethyl ether and 1-methoxy-2-butanol is used favorably.

The mixed liquid may contain binders, dispersants, stabilizers, and the like in addition to the above-mentioned components as appropriate.

Examples of the method of applying the mixed liquid include spin coating, gravure coating, spray coating, dip coating, and the like, among which spin coating is preferred.

Preferably, the thickness of thus formed first recording layer 20 is 50 to 300 nm. Outside of this range, the reflectance decreases, so that it is hard to perform reproduction in conformity to the DVD specification. When the thickness of the first recording layer 20 positioned on the groove 12 is 100 nm or greater, 130 to 300 nm in particular, the degree of modulation becomes very large.

Preferably, the extinction coefficient (imaginary part k of birefringence index) of the first recording layer with respect to the recording light and reproducing light is 0 to 0.20. A sufficient reflectance is harder to obtain when the extinction coefficient exceeds 0.20. Preferably, the refractive index (real part n of birefringence index) of the first recording layer 20 is at least 1.8. The degree of modulation of signals tends to become smaller when the refractive index is less than 1.8. Though not restricted in particular, the upper limit of refractive index is typically about 2.6 for the sake of synthesizing the organic dye.

The extinction coefficient and refractive index of the first recording layer 20 can be determined according to the following procedure. A recording layer is initially provided by about 40 to 100 nm on a predetermined transparent substrate, so as to produce a measurement sample, and then the reflectance of the measurement sample through the substrate or from the recording layer side is measured. In this case, the reflectance is measured by specular reflection (about 5°) using the wavelength of recording/reproducing light. Further, the transmittance of the sample is measured. From thus measured values, the extinction coefficient and refractive index can be calculated, for example, according to the method described in Ishiguro Kozo, “Optics”, Kyoritsu Zensho, pp. 168-178.

Semitransparent Reflecting Layer 30

The semitransparent reflecting layer 30 is a layer having an optical transmittance of at least 40% and an appropriate optical reflectance. The semitransparent reflecting layer 30 is desired to be low in light absorption and have a certain degree of corrosion resistance. Further, the semitransparent reflecting layer 30 has such a barrier property as to keep the first recording layer 20 from being affected by the leakage from the spacer layer 40.

Specifically, for example, a thin film of a metal or alloy having a high reflectance can be employed as the semitransparent reflecting layer 30.

As materials for the semitransparent reflecting layer 30, those having an appropriately high reflectance at the wavelength of reproducing light, e.g., metals and semimetals such as Au, Al, Ag, Cu, Ti, Cr, Ni, Pt, Ta, Pd, Mg, Se, Hf, V, Nb, Ru, W, Mn, Re, Fe, Co, Rh, Ir, Zn, Cd, Ga, In, Si, Ge, Te, Pb, Po, Sn, Bi, and rare-earth metals, can be used singly or in alloys. Among them, Au, Al, and Ag have a high reflectance and are suitable as materials for the semitransparent reflecting layer 30. In addition to these main ingredients, other ingredients may also be contained.

Preferred among them are alloys containing 50% or more of Ag, e.g., Ag—Bi alloys and the like. Preferably, the Ag concentration is 98 to 99.5 atom %.

For securing a high transmittance, it will typically be preferred if the thickness of the semitransparent reflecting layer 30 is 50 nm or less. More preferably, the thickness is 30 nm or less. Further preferably, the thickness is 20 nm or less. Since a certain thickness is required for keeping the first recording layer 20 from being affected by the spacer layer 40, however, the thickness is typically 3 nm or greater. More preferably, the thickness is 5 nm or greater.

Thin films having low and high refractive indexes may alternately be stacked, so as to form a multilayer film made of a material other than metals, and this film can be used as a reflecting layer.

Examples of the method of forming the semitransparent reflecting layer 30 include sputtering, ion plating, chemical vapor deposition, vacuum vapor deposition, and the like. For improving the reflectance, ameliorating recording characteristics, enhancing the adhesion, and so forth, known inorganic or organic intermediate layers and adhesive layers may be provided between the semitransparent reflecting layer 30 and first recording layer 20 and between the semitransparent reflecting layer 30 and spacer layer 40.

Spacer Layer 40

The spacer layer 40 is a transparent layer separating the semitransparent reflecting layer 30 and second recording layer 50 from each other.

Materials for the spacer layer 40 may be exemplified by thermoplastic resins, thermosetting resins, electron-beam-curable resins, UV-curable resins (including delayed-curing type), and the like.

The thermoplastic resin, thermosetting resin, and the like may be dissolved into an appropriate solvent, so as to prepare a coating liquid, which is then applied and dried. The UV-curable resin may be applied as it is or as a coating liquid prepared by dissolving it into an appropriate solvent, and formed by curing upon irradiation with UV rays. These materials may be used singly or as a mixture, not only in one layer but also in a multilayer film.

As the applying method, methods such as coating methods like spin coating and casting are used, among which spin coating is preferred. Resins having a high viscosity may also be applied by screen printing and the like. As the UV-curable resin, one which is liquid at 20 to 40° C. is preferably employed from the viewpoint of productivity, since it can be applied without using a solvent. Preferably, the viscosity is adjusted such as to fall within the range of 20 to 1000 mPa·s.

The UV-curable adhesives may be exemplified by radical-based UV-curable adhesives and cationic UV-curable adhesives. Examples of the radical-based UV-curable adhesives include compositions containing a UV-curable compound and an optical polymerization initiator as essential components. Examples of the UV-curable compound include monofunctional (meth)acrylate and polyfunctional (meth)acrylate. They can be used singly or in combination of two or more species.

Thus, the spacer layer 40 is typically made of a resin and therefore easily compatible with the second recording layer 50. Hence, a buffer layer may be provided between the spacer layer 40 and second recording layer 50 in order to restrain the second recording layer from being adversely affected. Also, in order to suppress damages to the semitransparent reflecting layer 30 as mentioned above, a buffer layer may be provided between the spacer layer 40 and semitransparent reflecting layer.

It is typically preferred that the thickness of the spacer layer 40 be 5 μm or greater. For independent focus servo control of the first recording layer 20 and second recording layer 50, a certain distance is required between the recording layers. Though depending on focus servo mechanisms, the distance required is typically 5 μm or greater, preferably 10 μm or greater.

However, it will typically be preferred if the distance is 100 μm or less, since the spacer layer 40 being too thick is problematic in that it takes time to place the two recording layers into focus by servo control, elongates the distance by which an objective lens moves, requires time to cure, thereby lowering the productivity, and so forth.

A groove 42 for the second recording layer 50 is formed on the spacer 40 as on the substrate 10. The groove 42 can be manufactured by the 2P method, i.e., by transferring irregularities of a resin stamper or the like to a curable resin such as photocurable resin and curing the latter.

Second Recording Layer 50

The second recording layer 50 is one formed by using a predetermined optical recording material. The second recording layer 50 contains a meal complex dye and an organic dye. The second recording layer 50 contains 10 to 80 parts by weight of the metal complex dye where the total amount of the metal complex dye and organic dye is 100 parts by weight. It will be preferred in particular if the second recording layer 50 contains 30 to 50 parts by weight of the metal complex dye where the total amount of the metal complex dye and organic dye is 100 parts by weight.

Examples of the metal complex dye and organic dye, the method of making the second recording layer 50, and the like are the same as those in the first recording layer 20 and thus will not be set forth here.

The metal complex dye in the second recording layer 50 may be identical to or different from the metal complex dye in the first recording layer 20. The organic dye in the second recording layer 50 may be identical to or different from the organic dye in the first recording layer 20.

Reflecting Layer 60

The reflecting layer 60 is a layer reflecting light, for which a thin film made of a metal or alloy with an optical reflectance can be employed, for example. Examples of the metal and alloy include gold (Au), copper (Cu), aluminum (Al), silver (Ag), and AgCu. Preferably, the thickness of the reflecting layer is 10 to 300 nm. Such a reflecting layer 60 can easily be formed by vapor deposition, sputtering, and the like.

Adhesive Layer 70

The adhesive layer 70 is a layer bonding the dummy substrate 80 and reflecting layer 60 to each other. Though not required to be transparent, the adhesive layer 70 preferably has a high bonding force and exhibits a low shrinkage ratio at the time of bonding by curing, since the morphological stability of the optical recording medium is enhanced thereby.

In order to restrain the reflecting layer 60 from being adversely affected, a known inorganic or organic protective layer may be provided between the adhesive layer 70 and reflecting layer 60.

For yielding a sufficient productivity while attaining a sufficient bonding force, it will typically be preferred if the thickness of the adhesive layer 70 is 2 μm or greater, more preferably 5 μm or greater. For making the optical recording medium as thin as possible and reducing the curing time in order to improve the productivity, however, it will typically be preferred if the thickness is 100 μm or less.

Hot-melt adhesives, UV-curable adhesives, thermosetting adhesives, sticky adhesives, pressure-sensitive double-sided tapes, and the like are used as a material for the adhesive layer 70 with their corresponding suitable methods such as roll coating, screen printing, spin coating, and the like, for example. In the case of DVD±R, UV-curable adhesives are used with screen printing or spin coating as comprehensively determined from the operability, productivity, disc characteristics, and the like.

Dummy Substrate 80

The dummy substrate 80 is a substrate similar to the substrate 10. Here, the dummy substrate is not required to be transparent.

Any other layers may be inserted in the optical recording medium 100 as necessary. Any other layers may also be provided on the outermost surface of the medium.

When recording or writing once on the optical recording medium 100 having the above-mentioned structure, the surface of the substrate 10 of the optical recording medium 100, i.e., the lower face of the optical recording medium 100 as shown in FIG. 1, is irradiated pulsewise with recording light having a predetermined wavelength. Namely, the outer surface of the substrate 10 in this optical recording medium becomes the light entrance surface 10a. Here, appropriate focusing causes a desirable part within the first recording layer 20 or second recording layer 50 to selectively absorb the energy of light, thereby changing the optical reflectance of the recording layer in this part.

When reading, it will be sufficient if reading light weaker than the recording one is similarly focused at a desirable part in the first recording layer 20 or second recording layer 50, and the difference in reflectance is measured.

In the optical recording medium 100 in accordance with this embodiment, since the dyes compounded in the first recording layer 20 and second recording layer 50 satisfy their respective conditions mentioned above, the recording powers in the first recording layer 20 and second recording layer 50 are substantially equivalent to each other, whereby the error rate after a high-temperature storage test exhibits a favorable value in each of the recording layers.

When the first recording layer 20 contains less than 60 parts by weight of the metal complex dye where the total amount of the metal complex dye and organic dye is 100 parts by weight, the error rate after the high-temperature storage test in the first recording layer increases. When the second recording layer 50 contains less than 10 parts by weight of the metal complex dye where the total amount of the metal complex dye and organic dye is 100 parts by weight, on the other hand, the error rate after the high-temperature storage test in the second recording layer increases. When the second recording layer 50 contains more than 80 parts by weight of the metal complex dye where the total amount of the metal complex dye and organic dye is 100 parts by weight, the recording power of the second recording layer increases so as to become out of balance with the recording power of the first recording layer.

Though the above-mentioned embodiment explains the optical recording disc equipped with two recording layers as the recording layers, three or more recording layers may be provided. When the above-mentioned conditions are satisfied, at least the first and second recording layers exhibit favorable initial error rates and favorable error rates after a light resistance test in the latter case as well.

### EXAMPLES

In the following, the present invention will be explained in further detail with reference to examples, which do not limit the present invention.

### Examples a1 to a12

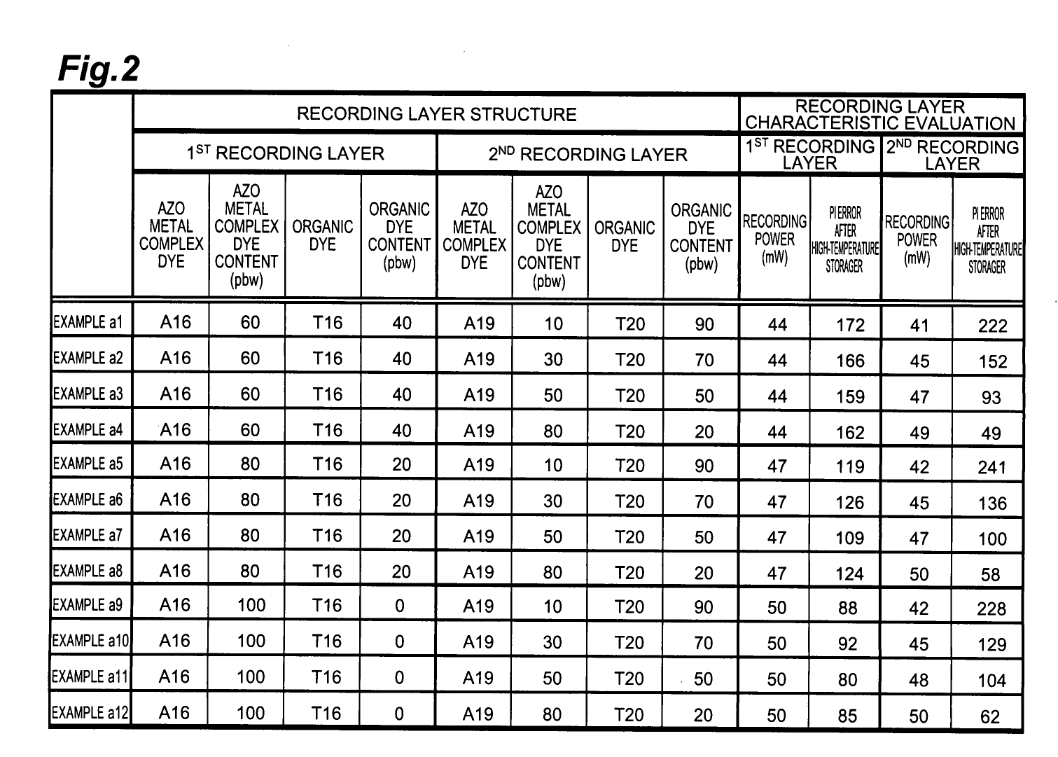

First, a polycarbonate substrate having a diameter of 120 mm and a thickness of 0.58 mm formed with a spiral pregroove on one side was prepared. Subsequently, azo metal complex dye A16 and cyanine dye T16 were added to 2,2,3,3-tetrafluoropropanol such as to yield the weight ratios in the first recording layer of Examples a1 to a12 shown in FIG. 2 and a total dye concentration of 0.8% by weight, thus preparing first recording layer coating liquids. Here, a salt of the azo metal complex dye A16 and tetrabutylammonium and a salt of the cyanine dye T16 and PF₆⁻ were used. Each of thus obtained first recording layer coating liquids was applied by spin coating at 2000 rpm onto the surface of the above-mentioned polycarbonate resin substrate formed with the pregroove and was dried for 1 hr at 80° C., so as to form the first recording layer (having a thickness of 110 nm). Then, a semitransparent reflecting layer (having a thickness of 12 nm) was formed on the first recording layer by sputtering with an Ag—Bi alloy.

Subsequently, a polyolefin stamper having a projection corresponding to a spiral groove of the second recording layer was prepared, the projection of the stamper made of polyolefin was arranged such as to oppose the semitransparent reflecting layer, a UV-curable resin was held between the stamper and semitransparent reflecting layer, the stamper and substrate were rotated at a high speed, so as to remove the excess of the UV-curable resin, and thereafter the UV-curable resin was cured by irradiation with UV rays through the polyolefin stamper. Then, the polyolefin was peeled off, so as to form a spacer layer (with a thickness of 55 μm) having a groove as a tracking groove on the semitransparent reflecting layer.

Next, azo metal complex dye A19 and cyanine dye T20 were added to 2,2,3,3-tetrafluoropropanol such as to yield the weight ratios in the second recording layer of Examples a1 to a12 shown in FIG. 2 and a total dye concentration of 1.0% by weight, thus preparing second recording layer coating liquids. Here, a salt of the azo metal complex dye A19 and tetrabutylammonium and a salt of the cyanine dye T19 and PF₆⁻ were used. Each of thus obtained second recording layer coating liquids was applied by spin coating at 2000 rpm onto the spacer layer and was dried for 1 hr at 80° C., so as to form the second recording layer (having a thickness of 130 nm). Then, a reflecting layer (having a thickness of 120 nm) was formed on the second recording layer by sputtering with Ag.

Further, a polycarbonate substrate having a diameter of 120 mm and a thickness of 0.58 mm was prepared and arranged such as to oppose the reflecting layer, a UV-curable resin was held between the reflecting layer and polycarbonate substrate, the lower and upper substrates were rotated at a high speed, so as to remove the excess of the UV-curable resin, and the UV-curable resin was cured by irradiation with UV rays through the upper transparent substrate, so as to form an adhesive layer, thereby completing an optical recording medium.

Then, the recording power of thus obtained optical recording medium was measured with an optical disc evaluation apparatus (ODU-1000) manufactured by Pulsetec Industrial Co., Ltd., which was equipped with a laser having a wavelength of 650 nm and an optical head in which NA=0.65. Here, with a linear speed of 30.72 m/s (8× recording), the recording power was determined as a value yielding an eye pattern in which the center of the eye was positioned at the center of a 14T waveform. Subsequently, after recording on each of the first and second recording layers at this recording power, the PI (Inner-code-Parity) error (number of errors per ECC block) after a high-temperature storage test was determined. The condition of the high-temperature storage test was such that the optical recording medium was left for 1000 hr at 60° C.

### Comparative Examples a1 to a30

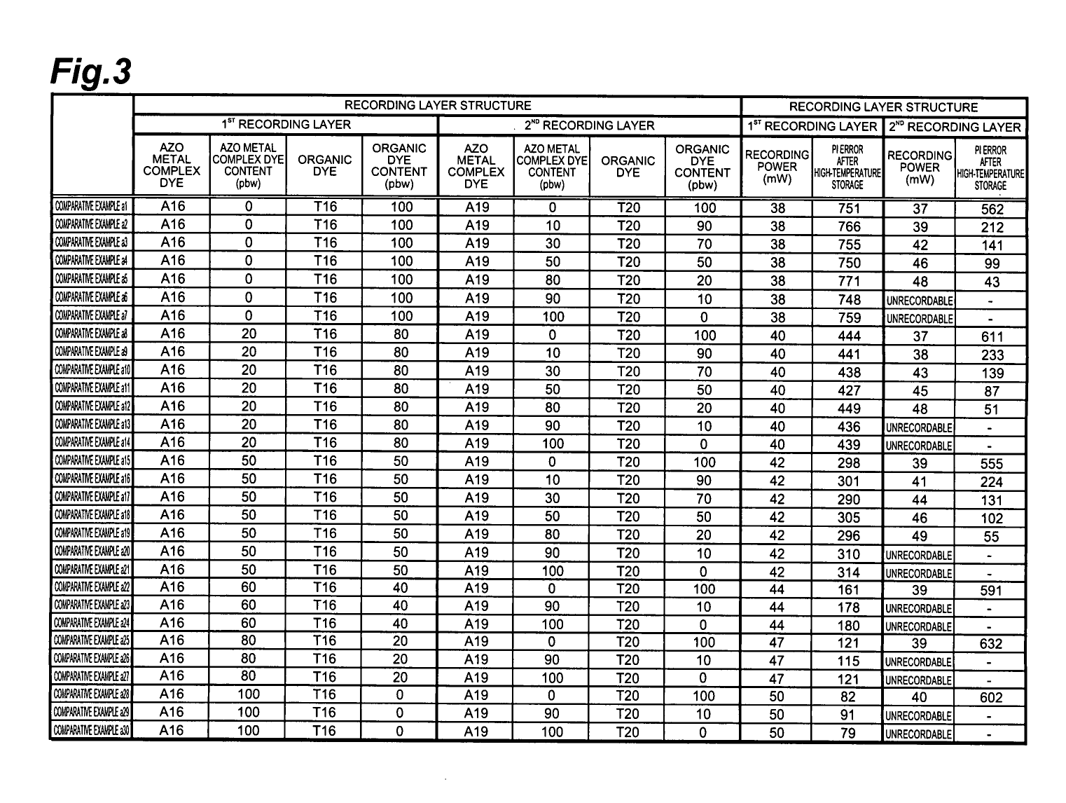

Optical recording media were made as in Example a1 except that the compounding ratios of dyes in the first and second recording layers became those of Comparative Examples a1 to a30 in FIG. 3, and each recording layer was evaluated.

FIGS. 2 and 3 show the results. The difference in recording power between the first and second recording layers is desired to be 10 mW or less in 8× recording. The PI error after the high-temperature storage test is desired to be 280 or less. In the drawings, “unrecordable” means that recording was impossible even when the recording power of the apparatus was at the higher limit.

In Examples a1 to a12 in which the first recording layer contained 60 to 100 parts by weight of the metal complex dye where the total amount of the metal complex dye and organic dye was 100 parts by weight while the second recording layer contained 10 to 80 parts by weight of the metal complex dye where the total amount of the metal complex dye and organic dye was 100 parts by weight, the balance between the recording powers of the first and second recording layers was excellent, and the PI error after the high-temperature storage test was 280 or less in each recording layer.

In Examples a2, a3, a6, and a7 in which the first recording layer contained 60 to 80 parts by weight of the metal complex dye where the total amount of the metal complex dye and organic dye was 100 parts by weight while the second recording layer contained 30 to 50 parts by weight of the metal complex dye where the total amount of the metal complex dye and organic dye was 100 parts by weight in particular, the recording powers not only yielded smaller balances therebetween but also were sufficiently low, and the PI errors after the high-temperature storage test were particularly favorable in the first and second recording layers.

On the other hand, favorable values of recording power balance and PI errors in both recording layers after the high-temperature storage test could not be attained in Comparative Examples a1 to a30 failing to satisfy the above-mentioned conditions.

### Examples b1 to b11

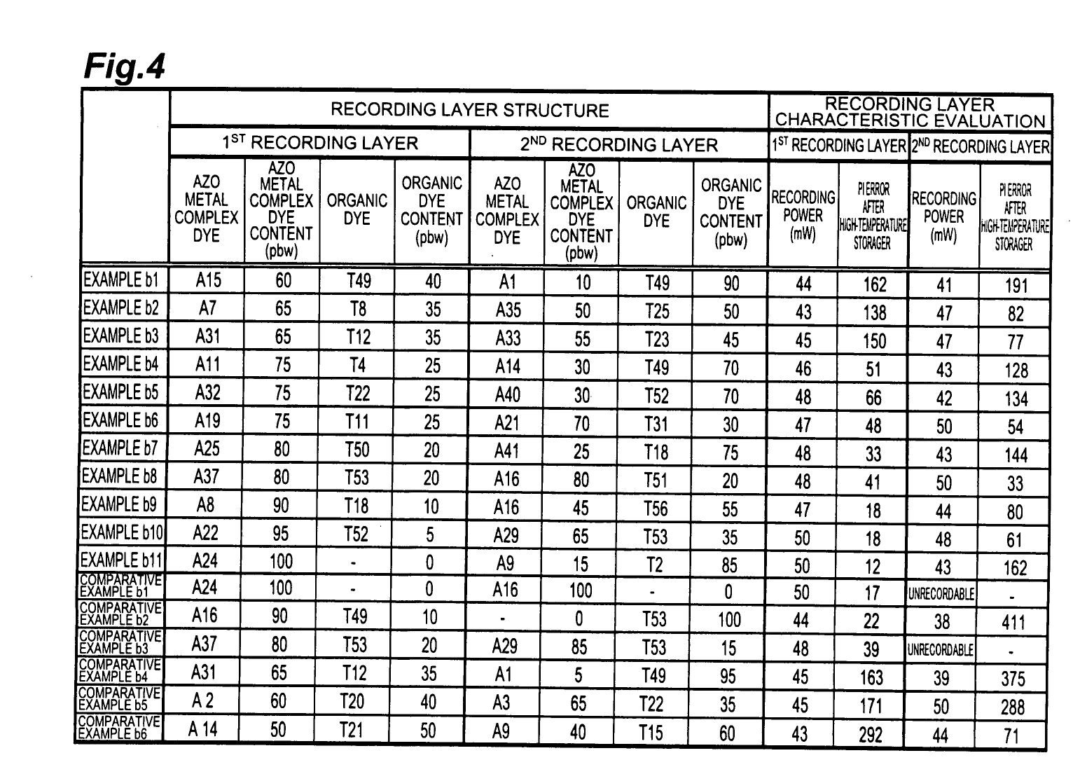

Optical recording media were made as in Example a1 except that the species and compounding ratios of azo metal complex dyes and organic dyes in the first recording layer and the species and compounding ratios of azo metal complex dyes and organic dyes in the second recording layer became those of Examples b1 to b11 in FIG. 4, and each recording layer was evaluated.

### Comparative Examples b1 to b6

Optical recording media were made as in Example b1 except that the species and compounding ratios of azo metal complex dyes and organic dyes in the first recording layer and the species and compounding ratios of azo metal complex dyes and organic dyes in the second recording layer became those of Comparative Examples b1 to b6 in FIG. 4, and each recording layer was evaluated.

Here, salts with PF₆⁻ were used for anions, whereas salts with tetrabutylammonium were used for cations.

The recording power balance and PI errors of both recording layers after the high-temperature storage test were also favorable here in Examples b1 to b11 in which the first recording layer contained 60 to 100 parts by weight of the metal complex dye where the total amount of the metal complex dye and organic dye was 100 parts by weight while the second recording layer contained 10 to 80 parts by weight of the metal complex dye where the total amount of the metal complex dye and organic dye was 100 parts by weight. On the other hand, neither the recording power balance and PI error after the high-temperature storage test was favorable in Comparative Examples b1 to b6 failing to satisfy the above-mentioned conditions.

1. An optical recording medium comprising at least two recording layers laminated;
wherein each of the recording layers contains predetermined concentrations of a metal complex dye and an organic dye;
wherein the recording layers are referred to as first and second recording layers successively from a light entrance surface side;
wherein the first recording layer contains 60 to 100 parts by weight of a metal complex dye where the total amount of the metal complex dye and organic dye is 100 parts by weight; and
wherein the second recording layer contains 10 to 80 parts by weight of a metal complex dye where the total amount of the metal complex dye and organic dye is 100 parts by weight.

2. An optical recording medium according to claim 1, wherein the first recording layer contains 60 to 80 parts by weight of the metal complex dye where the total amount of the metal complex dye and organic dye is 100 parts by weight.

3. An optical recording medium according to claim 1, wherein the second recording layer contains 30 to 50 parts by weight of the metal complex dye where the total amount of the metal complex dye and organic dye is 100 parts by weight.

4. An optical recording medium according to claim 1, wherein the metal complex dye is an azo metal complex dye.

5. An optical recording medium according to claim 4, wherein the azo metal complex dye is a complex compound formed by an azo compound represented by the following general formula (1) and a metal: 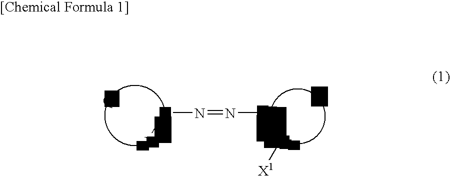
where, in formula (1), Q¹ indicates a divalent residue forming a heterocyclic ring or a fused ring including the heterocyclic ring by combining with each of a nitrogen atom and a carbon atom combined to the nitrogen atom, Q² indicates a divalent residue forming a fused ring by combining with each of two carbon atoms combined to each other, and X¹ indicates a functional group having at least one active hydrogen atom.

6. An optical recording medium according to claim 1, wherein the organic dye is a cyanine dye.

7. An optical recording medium according to claim 6, wherein the cyanine dye has a group represented by the following general formula (2) or (3): 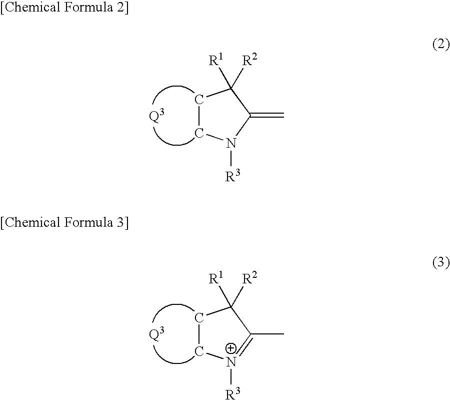
where, in formulas (2) and (3), Q³ indicates an atom group constituting a benzene ring which may have a substituent or a naphthalene ring which may have a substituent; R¹ and R² independently indicate an alkyl group, a cycloalkyl group, a phenyl group, or a benzyl group which may have a substituent, or groups forming a 3- to 6-membered ring by combining with each other; R³ indicates an alkyl group, a cycloalkyl group, an alkoxy group, a phenyl group, or a benzyl group which may have a substituent; and the groups expressed by R¹, R², and R³ may have a substituent.

8. An optical recording medium according to claim 1, having the recording layers by only two layers.

9. An optical recording medium according to claim 1, comprising:
a substrate;
the first recording layer provided on the substrate;
a semitransparent reflecting layer provided on the first recording layer;
a spacer layer provided on the semitransparent layer;
the second recording layer provided on the spacer layer; and
a reflecting layer provided on the second recording layer.

10. An optical recording medium according to claim 2, wherein the second recording layer contains 30 to 50 parts by weight of the metal complex dye where the total amount of the metal complex dye and organic dye is 100 parts by weight.
